(19) United States
(12) Patent Application Publication
(10) Pub. No.: US 2019/0180317 A1
(43) Pub. Date: Jun. 13, 2019

(54) SELECTING CONTENT ITEMS BASED ON EXPECTED CONTRIBUTION TO DESIRED INTERACTIONS

(71) Applicant: Facebook, Inc., Menlo Park, CA (US)

(72) Inventor: Toby Jonas F. Roessingh, Woodside, CA (US)

(21) Appl. No.: 15/834,558

(22) Filed: Dec. 7, 2017

(51) Int. Cl. G06Q 30/02

(52) U.S. Cl. CPC G06Q 30/0246; G06Q 30/0254

(57) ABSTRACT

An online system receives a data stream of reported interaction events that resulted in each of a desired interaction with a content item. Each reported interaction event is associated with an attribution value defining a portion of a value of a desired interaction that is attributed to the interaction event. Using the attribution values, an attribution model is trained that determines an expected value of presenting the content item associated with the attribution model. The online system uses attribution models of a plurality of candidate content items to select content items for presentation to users of the online system.

### BACKGROUND

This disclosure relates generally to online content presentation, and in particular to selecting content items based on externally-assigned influence of online content items towards user interactions.

A user often views or interacts with multiple online content items related to a desired interaction before the user decides to perform the desired interaction. Such content items may refer to the same company, product, or service related to the desired interaction. For example, a desired interaction may include a user's decision to engage with an application or website, or visit a real-world location. The various content items related to the desired interaction may be presented to the consumers by many different content publishers, including different websites or applications. Consumers may also view the content items using multiple different devices. Each of these content items presented to the user may influence the user in different ways.

When a desired interaction occurs, an attribution system may designate a value allocated to each content item related to the desired interaction, which may have been provided to a user across several systems that provide content. The criteria for designating that value may be unknown by the systems that are selecting whether to present a content item, and may thus make it challenging for these systems to effectively determine when selecting content to present a user what value may prospectively be assigned to that content item.

### SUMMARY

An online system selects content items to display to its users based on expected attribution values of the content items. The online system receives a data stream of reported interaction events that resulted in a plurality of desired interactions. Each desired interaction is associated with one or more interaction events that occurred before (and partially led to) the desired interaction. The interaction events are each associated with a content item, and can include a user interaction with the associated content item. The user interaction may be a user viewing a content item, or an interaction of the user with the content item or a user's interaction after viewing the content item that led towards the desired interaction. Each interaction event is also associated with an attributed value, assigned by the attribution system, defining a portion of a value of a desired interaction that is attributed to the interaction event. The online system uses the attributed values in the received data stream to predict the value to the online system of presenting a content item. To predict the value of presenting a content item, the online system trains an attribution model for that content item based on the interaction events, desired interactions, and attributed values from the data stream. The attribution model predicts the expected attribution value of presenting the content item to a user. The online system uses the interaction events, desired interactions, and attribution values associated with the content item to train the attribution model for the content item. The online system may train an attribution model for each content item to be presented by the online system. In some embodiments, the online system may train models for different content generators or different sets of similar users.

When the online system identifies an opportunity to present a content item to a user, the online system selects a content item to fill the opportunity based at least in part on an expected attribution value predicted by a trained attribution model associated with the content item. The online system uses the expected attribution value for the content item output by the attribution model to determine whether to select the content item for presentation to users of the online system. In some embodiments, the online system uses the expected attribution value for a content item to select the content item via an auction process.

### BRIEF DESCRIPTION OF THE DRAWINGS

FIG. 1 (FIG. 1) is a high-level block diagram of a system environment for an online system, according to one embodiment.

FIG. 2 illustrates an example event stream for a desired interaction.

FIG. 3 is an example block diagram of an architecture of the online system, according to one embodiment.

FIG. 4 is an interaction diagram illustrating one embodiment of a process for providing content items to users based on expected attribution values, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

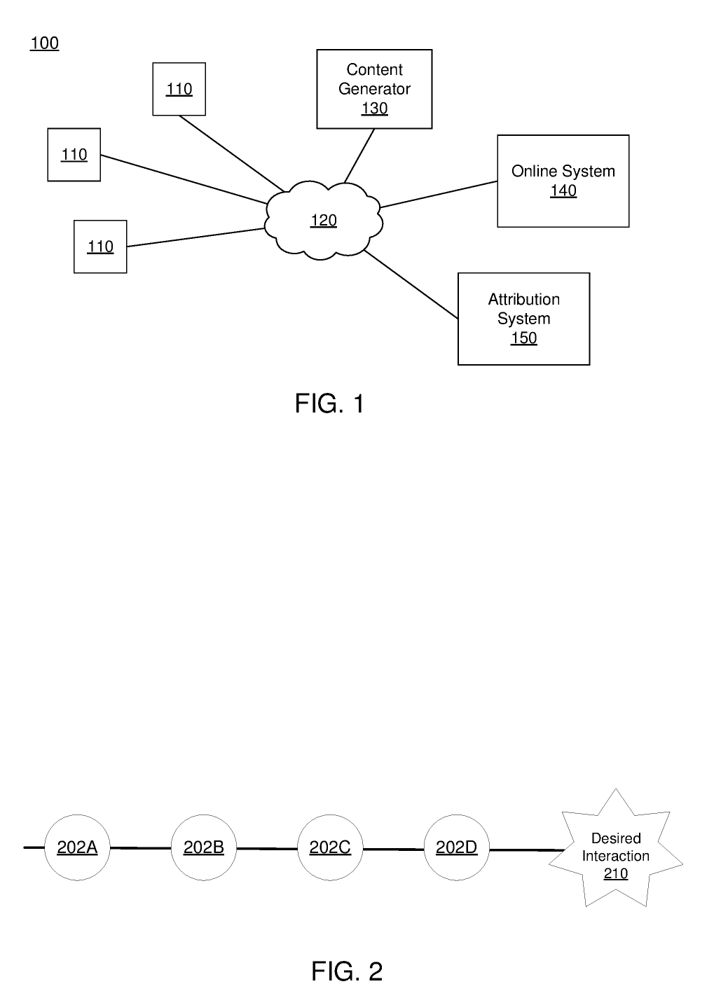

FIG. 1 is a high level block diagram of a system environment 100 for an online system 140, such as a social networking system. The system environment 100 shown by FIG. 1 comprises one or more client devices 110, a network 120, one or more content generators 130, the online system 140, and an attribution system 150. In alternative configurations, different and/or additional components may be included in the system environment 100. Although embodiments are described herein with respect to a social networking system, these embodiments can be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™. Multiple client devices 110 may be associated with a given user of the online system 140. The multiple client devices may be associated with one user after the user enters user credentials for a user account for the online system into each of the client devices. Once associated with the user, the online system 140 may infer the user's continued use of the multiple devices after the user has logged out of the user account.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more content generators 130 are coupled to the network 120 for communicating with the online system 140. The content generators 130 generate and provide content items for publishing by the online system 140 and display to users of the client devices 110. Content generators 130 may be users of the online system 140 or may be third-party systems in communication with the online system 130. In addition to content items, the content generators 130 may provide targeting criteria, specifying characteristics of users to whom the content items should be displayed, and optimization goals, specifying objectives for content item delivery. In one embodiment, a plurality of content generators 130 provide content items to the online system 140, which selects and provides content items for display to users based at least in part on targeting criteria specified by the respective content generator 130. The content generator 130 may also define types of desired interactions that are of interest to the content generator 130. For example, one content generator 130 may specify that a user has performed the desired interaction with a content item when the user clicks on the content item, while another content generator 130 may specify that a user has performed the desired interaction with a content item if the user purchases a product described by the content item. The content generator 130 may provide content items to other publishers not illustrated in FIG. 1 for display via the client devices 110.

The online system 140 is a content publisher that provides content items for display to users via the client devices 110. The online system 140 selects the content items to provide to users based on targeting criteria or bid values provided by the content generators 130, bid values generated by the online system 140, preferences of the users, or other information. The online system 140 may also provide other content for display to users. For example, the online system 140 provides a website or application configured to be displayed by the client devices 110, and selects content items for display with the website or application content.

A user may be presented with multiple content items or the same content item multiple times for a specific product or service before deciding to take an action relating to the content item, such as making a purchase of a product or a service. Each of those content item presentations or user interactions with the content items may have an influence on the final decision by the user to take the action that results in a desired interaction of interest to the content generator 130. The attribution system 150 identifies desired interactions of the content items provided by the content generators 130, and attributes proportional value of the desired interactions to one or more interaction events. Each interaction event is associated with a content item and a user action related to the content item, such as viewing the content item, clicking a link in the content item, or sharing the content item with one or more other users of the online system 140. The attribution system 150 may receive interaction events associated with content items displayed by the online system 140, as well as content items displayed by other content publishers. The set of interaction events that contribute to a desired interaction are referred to herein as an “event stream.”

The attribution system 150 determines the amount of the influence that can be attributed to each interaction event in an event stream associated with each desired interaction. In one embodiment, the attribution system 150 receives information about the interaction events from the online system 140 and other publishers of content items and uses the received information to determine attribution values for each interaction event. The attribution system 150 in turn sends the attribution values to the online system 140 or the content generators 130. Although the attribution system 150 is shown in FIG. 1 as a system operated independently of the content generators 130 and the online system 140, the attribution system 150 may be operated by the content generator 130 or the online system 140 in other embodiments.

FIG. 2 illustrates an example of an event stream for a desired interaction 210. The example event stream includes a sequence of interaction events 202 determined to have contributed to a desired interaction. As described above, the interaction events 202 may include an instance of a presentation of a content item associated with the desired interaction 210, a click event associated with a content item, a user input to share a content item, or another type of interaction event. Each interaction event has various properties, including, for example, an identifier of an content item associated with the interaction event, an identifier of the user, a date and time at which the interaction event occurred, a location at which the content item associated with the interaction event was displayed, a product described by the content item associated with the interaction event, and a type of user device that displayed the associated content item. The interaction events 202 in the event stream may be associated with different content items or with the same content item, for example if a user viewed the same content item multiple times. In one embodiment, the event stream reported to the online system 140 by the attribution system 150 comprises any interaction events associated with the online system 140, such as any content item presentations on a website provided by the online system 140, but does not include interaction events associated with other systems.

As explained above, the attribution system 150 determines an attribution value for each interaction event 202 in the event stream. The attribution value is based on the attribution of the interaction event, or the amount of influence the interaction event had on the user leading up to the desired interaction 210. Different interaction events may have different amounts of influence. For example, a content item shown on a mobile device may have a different influence on a user's decision to purchase a product than a content item shown on a home computer. Similarly, a content item shown during work hours may have a different influence on the user's decision to purchase a product than a content item shown at night. The interaction events 202 are each assigned an attribution value proportional to the amount of influence provided by the interaction event. Out of the four interaction events 202 in the example event stream, which collectively provided 100% of the influence necessary to cause the desired interaction 210, the interaction event 202B was determined to provide 45% of the influence. The interaction event 202A, in contrast, contributed 10%. The attributions associated with interaction events may alternatively be represented as an amount of value each interaction event contributed to a desired interaction. For example, if the desired interaction 210 was worth $10 to a content generator 130, the interaction event 202A contributed $1. If the desired interaction 210 is associated with other interaction events not in the reported event stream (e.g., if the attribution system 150 determines an interaction event associated with an external system contributed to the desired interaction 210), the attributions in the reported stream may not add up to 100% or the full value of the desired interaction. For example, if the attribution system 150 determines a fifth interaction event contributed 10% of the influence on the user, the attributions reported to the online system 140 may sum to only 90%.

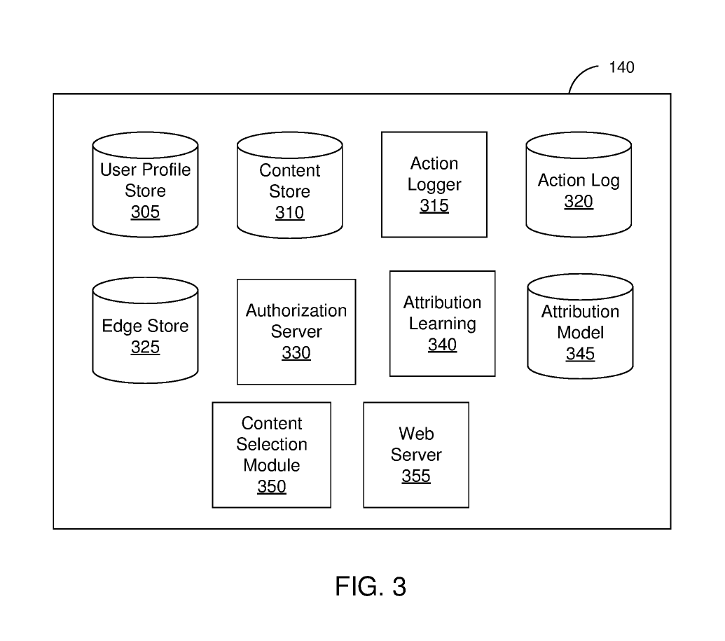

FIG. 3 is an example block diagram of the architecture of the online system 140, according to one embodiment. In the embodiment of FIG. 3, the online system 140 operates as a social networking system and includes a user profile store 305, a content store 310, an action logger 315, an action log 320, an edge store 325, an authorization server 330, an attribution learning module 340, one or more attribution models 345, an content item selection module 350, and a web server 355. In other embodiments, the online system 140 may include additional, fewer, or different components for various applications. For example, the online system 140 may be any other system providing content users over a network, and thus may not include one or more components listed in FIG. 3 that provide social networking functionality. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 305. A user profile includes declarative information about the user that was explicitly shared by the user and may also include profile information inferred by the online system 140. In one embodiment, a user profile includes multiple data fields, each describing one or more attributes of the corresponding user of the online system 140. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the online system 140 displayed in an image. A user profile in the user profile store 305 may also maintain references to actions by the corresponding user performed on content items in the content store 310 and stored in the action log 220.

The content store 310 stores information describing content items received from one or more users or content generators 130. A content item includes content item content, such as a page post, a status update, a photograph, a video, a link, a shared content item, a gaming application achievement, a check-in event at a local business, a brand page, or any other type of content. Content item information received from content generators 130 can include one or more content item requests that each describe content items for presentation to one or more users of the online system 140. In various embodiments, the content item also includes a link to a landing page specifying a network address to which a user is directed when the content item is accessed. A content item request may also include a baseline bid amount with a content item. The baseline bid amount is associated with a content item by a content generator 130 and is used in some embodiments to determine monetary compensation provided by a user to the online system 140 if the content item is presented to a user, if the content item receives a user interaction, or based on any other suitable condition. For example, the baseline bid amount relates to a minimum or maximum monetary amount that the online system 140 receives from the content generator 130 if the content item is displayed. Content generators 130 may also provide information relating to value of desired interactions to the content generator 130, where a desired interaction may include, for example, a specified user interaction with a content item (e.g., a selection of a link provided in the content item), a user's decision to purchase a product or service associated with a content item, or a user's action to share the content item with one or more other users of the online system 140. A desired interaction, and the value associated with it by a content generator 130, may be based on one or more content item requests in the content store 310. For example, a content generator 130 may specify a value a desired interaction has to the content generator 130, where the desired interaction is a user's purchase of a product described by multiple different content item requests in the content store 310.

A content item request in the content store 310 may also include one or more targeting criteria specified by the content generator 130. Targeting criteria included in a content item request specify one or more characteristics of users eligible to be presented with content in the content item request. For example, targeting criteria are a filter to apply to fields of a user profile, edges, and/or actions associated with a user to identify users having user profile information, edges, or actions satisfying at least one of the targeting criteria. Hence, the targeting criteria allow a content generator 130 to identify groups of users matching specific targeting criteria, simplifying subsequent distribution of content to groups of users. The targeting criteria may additionally or alternatively specify actions or types of connections between a user and another user or object of the online system 140 or interactions between a user and objects performed external to the online system 140.

The action logger 315 receives communications about user actions internal to and/or external to the online system 140, populating the action log 320 with information about user actions. Examples of actions include adding a connection to another user, sending a message to another user, uploading an image, reading a message from another user, viewing content associated with another user, attending an event posted by another user, among others. In addition, a number of actions may involve an object and one or more particular users, so these actions are associated with those users as well and stored in the action log 320.

The action log 320 may be used by the online system 140 to track user actions on the online system 140. Users may interact with various objects on the online system 140, and information describing these interactions are stored in the action log 320. Examples of interactions with objects include: commenting on posts, sharing links, and checking-in to physical locations via a mobile device, accessing content items, and any other interactions. Additional examples of interactions with objects on the online system 140 that are included in the action log 320 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 320 may record a user's interactions with content items on the online system 140 as well as with other applications operating on the online system 140. In some embodiments, data from the action log 320 is used to infer interests or preferences of a user, augmenting the interests included in the user's user profile, and allowing a more complete understanding of user preferences.

The action log 320 may also store user actions taken on external systems, such as an external website, and communicated to the online system 140. For example, an e-commerce website that primarily sells sporting equipment at bargain prices may recognize a user of the online system 140 through a social plug-in enabling the e-commerce website to identify the user of the online system 140. Because users of the online system 140 are uniquely identifiable, e-commerce websites, such as this sporting equipment retailer, may communicate information about a user's actions outside of the online system 140 to the online system 140 for association with the user. Hence, the action log 320 may record information about actions users perform on an external system, including webpage viewing histories, content items that were engaged, purchases made, and other patterns from shopping and buying.

In one embodiment, an edge store 325 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the social networking system, sharing a link with other users of the social networking system, and commenting on posts made by other users of the social networking system. Users and objects within the social networking system can be represented as nodes in a social graph that are connected by edges stored in the edge store.

In one embodiment, an edge may include various features each representing characteristics of interactions between users, interactions between users and object, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The authorization server 330 enforces one or more privacy settings of the users of the online system 140. A privacy setting of a user determines how particular information associated with a user can be shared, and may be stored in the user profile of a user in the user profile store 305 or stored in the authorization server 330 and associated with a user profile. In one embodiment, a privacy setting specifies particular information associated with a user and identifies the entity or entities with whom the specified information may be shared. For example, a privacy setting specifies whether, and what, information about a user can be shared with the content generator 130 or the attribution system 150.

The attribution learning module 340 applies machine learning techniques to generate a plurality of attribution models 345 that predict the expected attribution value of presenting content items associated with the attribution models 345 to users of the online system 140. As part of the generation of the attribution models 345, the attribution learning module 340 forms training sets of interaction events from a plurality of the event streams received from the attribution system 150. As described above, each event stream represents one or more interaction events associated with a desired interaction. Each interaction event in the event stream is tagged with an attributed value, such as the interaction event's proportionate contribution to the desired interaction (e.g., 40%) or the interaction event's value (e.g., $2). In one embodiment, the attribution learning module 340 forms training sets with interaction events corresponding to a single content item request in the content store 310, such as content items presentations or click events associated with the content of the content item request. The attribution learning module 340 may alternatively form training sets with event streams corresponding to multiple content item requests from a content generator 130, or corresponding to multiple content generators' 130 content items. For example, a training set includes event streams associated with given content items from the content generator 130. An alternative training set may include event streams associated with a set of similar users as determined using information in the user profile store 305, regardless of the content generators 130 whose content items are associated with the interaction events in the event streams.

The attribution learning module 340 extracts feature values from the interaction events in the training sets, where the features include the value attributed to each interaction event (e.g., a percentage of attribution for a desired interaction, or an amount of money the interaction event was worth to the content generator 130) and properties deemed potentially relevant to the interaction event's contribution to a desired interaction. For example, the feature values extracted by the attribution learning module 340 may include the location at which a content item corresponding to the interaction event is displayed (e.g., in a newsfeed or in a sidebar), format of the content item (e.g., video or text), the time of day at which the content item is displayed (e.g., morning or evening), the type of device 110 that displayed the content item (e.g., mobile device or desktop computer), and physical properties of the content item (e.g., font size or color). An ordered list of the features for an interaction event is herein referred to as the feature vector for the interaction event. In one embodiment, the attribution learning module 340 applies dimensionality reduction via linear discriminant analysis (LDA), principle component analysis (PCA), or the like, to reduce the amount of data in the feature vectors for interaction events to a smaller, more representative set of data.

The attribution learning module 340 uses supervised machine learning to train the attribution models 345, where the inputs used to train each model are the feature vectors of the interaction events from one or more of the training sets. Different machine learning techniques—such as linear support vector machine (linear SVM), boosting for other algorithms (e.g., AdaBoost), neural networks, logistic regression, naïve Bayes, memory-based learning, random forests, bagged trees, decision trees, boosted trees, or boosted stumps—may be used in different embodiments. Because training sets may include content items associated with a specific content generator 130, associated with a set of similar users, or having other common characteristics, the attribution learning module 340 may generate attribution models 345 specific to a content item, content generator 130, user type, etc. Furthermore, the attribution learning module 340 may continually update the models 345 as new event streams are received from the attribution system 350, or may periodically generate new models using recent data. The attribution models 345, when applied to the feature vector extracted from an interaction event, outputs an expected value of the interaction event. The expected value output by the models 345 may be represented as a percentage contribution towards a desired interaction or as an amount of money the interaction event is worth to a corresponding content generator 130.

The content item selection module 350 uses the expected attribution values generated by attribution models 345 to select content items for presentation to users of the online system 140. The content item selection module 350 can select content items may be selected based on one or more optimization goals may specified by a content generator 130 or selected by the online system 140. For example, the optimization goals of a content generator 130 may include a number of desired interactions, value of desired interactions for the content generator 130, or amount of money spent for presenting content items. Optimization goals of the online system 140 may include a number or rate of desired interactions or content item revenue. When the content item selection module 350 receives notification of an opportunity to present a content item to a user, the content item selection module 350 predicts the expected attribution values of candidate content items for the opportunity and selects a content item for presentation to a user via the opportunity. In one embodiment, the content item selection module 350 determines scores for each of the candidate content items based at least in part on the expected attribution values given by the attribution models 345. The content item selection module 350 may also use other information to determine scores for the candidate content items, such as targeting criteria and bid values provided by corresponding content generators 130. The content item selection module 350 can select a content item to fill the opportunity based on the determined scores.

The web server 355 links the online system 140 via the network 120 to the one or more client devices 110, as well as to the one or more content generators 130 and the attribution system 150. The web server 355 serves web pages, as well as other web-related content, such as JAVA®, FLASH®, XML, and so forth. The web server 355 may receive and route messages between the online system 140 and the client device 110, for example, instant messages, queued messages (e.g., email), text messages, short message service (SMS) messages, or messages sent using any other suitable messaging technique. A user may send a request to the web server 355 to upload information (e.g., images or videos) that are stored in the content store 310. Additionally, the web server 355 may provide application programming interface (API) functionality to send data directly to native client device operating systems, such as IOS®, ANDROID™, WEBOS®, or RIM®.

### Optimizing Content Item Selection Based on Attributions

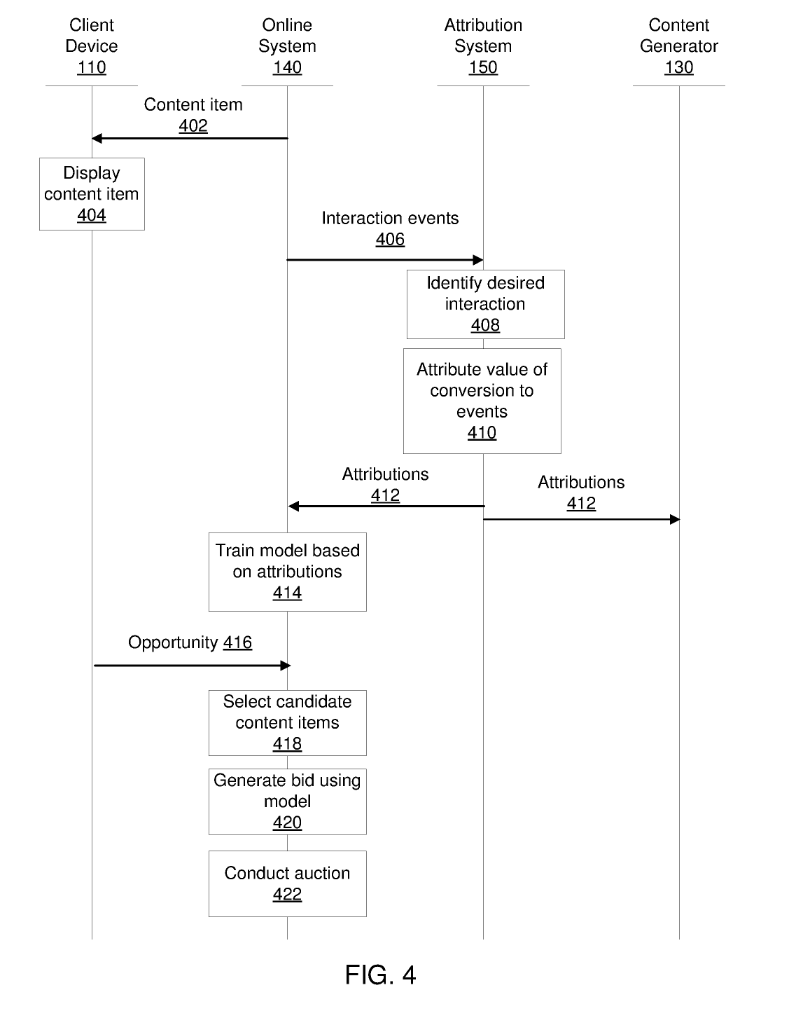

FIG. 4 is an interaction diagram illustrating one embodiment of a process for selecting content items using expected values of content items. The process shown in FIG. 4 comprises interactions between one or more client devices 110 associated with a user, the online system 140, the attribution system 150, and one or more content generators 130. Other embodiments may include additional, fewer, or different steps, and the steps may be performed in different orders.

The online system 140 provides content items 402 to the one or more client devices 110, which display 404 the content items to the user. The content items 402 are provided to the online system 140 by the content generator 130, and may be associated with targeting criteria or other criteria used by the online system 140 to select content items to provide to the user. The content items may be displayed 404 within or associated with content provided by the online system 140 or another online system, or may be displayed alone without associated content. Furthermore, a variety of types and formats of content items may be provided to the client device 110. For example, the online system 140 provides content items 402 that are displayed intermixed with content of the online system 140 (e.g., in a newsfeed), content items displayed next to content of the online system 140 (e.g., in a sidebar or banner), and content items overlaid on content of the online system 140 (e.g., as a pop-up). Users of the client devices 110 may interact with the displayed content items or purchase described products or services.

The online system 140 reports 406 interaction events related to the content items to the attribution system 150. Reported data may include data describing any action related to the content items, such as identifiers of content items that were displayed at the client device 110, click data reported from the client device 110 to the online system 140, user feedback related to the content, or user actions to share the content items with other users of the online system 140. The attribution system 150 may also receive reported interaction events from systems other than the online system 140.

The attribution system 150 tracks interaction events and identifies 408 a desired interaction of a content item related to one or more of the interaction events. Depending on the type of desired interaction that is of interest to the content generator 130, the attribution system 150 may determine a desired interaction based on the interaction events reported by the online system 140 or other online systems, or may receive a notification from an external system that a desired interaction has occurred. For example, if a content generator 130 defines a desired interaction as a click event associated with a content item, the attribution system 150 identifies that a desired interaction has occurred when the online system 140 reports a click event received at the content item. Alternatively, if a content generator 130 defines a desired interaction as purchasing the content generator's 130 product, an online shopping system may notify the attribution system 150 when a user has purchased the product. The content generator 130 may additionally or alternatively report desired interactions of interest to the attribution system 150.

When a desired interaction has been identified, the attribution system 150 identifies one or more interaction events that may have influenced the desired interaction and attributes 410 proportional value of the desired interaction to the one or more interaction events. The attribution system 150 may determine the desired interaction to have been influenced by any number of interaction events that were associated with the same user and content items related to the desired interaction. The interaction events associated with the desired interaction may include interaction events received from multiple client devices 110 of the user, as well as interaction events associated with content items distributed by systems other than the online system 140. The attribution system 150 sends 412 the determined attributions to the content generator 130 and the online system 140, which may use the attributions to monitor the effectiveness of various content items and tailor the content items or content item delivery in response. The attribution system 150 may send 412 the content generator 130 and the online system 140 complete event streams, representing a desired interaction and the value of the desired interaction attributed to each of one or more interaction events. Alternatively, the attribution system 150 may send 412 attributed values associated with individual interaction events, without reference to a desired interaction.

Using the attributions and properties of the interaction events in each of a plurality of event streams, the online system 140 trains 414 at least one model for attributing value of a desired interaction to individual interaction events. The online system 140 trains an attribution model for each content item in the content store 310 using attributed values, interaction events, and desired interactions in the event stream associated with the content item. The online system 140 also may train attribution models for each of a plurality of content generators 130 or for each of a plurality of sets of similar users. Each trained model, when applied to characteristics of a candidate interaction event, is configured to output an expected value of the candidate interaction event. The expected value represents an amount of influence or monetary value the candidate interaction event is expected to contribute towards a desired interaction.

As a user interacts with the online system 140, the client device 110 notifies 416 the online system 140 of an opportunity to present content items. For example, a user of the client device 110 requests to view a page of content from the online system 140 that includes space for one or more content items, and the client device 110 requests the page and content items from the online system 140. The client device 110 may also send information about the opportunity to present content items to the online system 140, such as an identifier of the user and an identifier of the client device 110. The online system 140 may determine properties of the opportunity when the notification is received, including the time of the request, the location of the spaces for content items, or other information.

The online system 140 selects 418 one or more candidate content items to fill the opportunity to present content items. Candidate content items are selected in one embodiment based on targeting criteria associated with content item requests in the content store 310. For example, the online system 140 selects a set of candidate content items from each of a plurality of content generators 130 that have targeting criteria met by the user requesting the page, the content of the page, or other characteristics of the opportunity to present content items.

Using the trained attribution models associated with the candidate content items, the online system 140 can generate 420 bids for selecting each candidate content items to fill the content item opportunity based on the expected attribution values for the candidate content items. Based on the expected value for filling the opportunity with a candidate content item, the online system 140 generates 420 the bid value for the candidate content item. The bid value represents an amount of compensation to be expected paid by an associated content generator 130 if the online system 140 selects the candidate content item to fill the opportunity. In one embodiment, the online system 140 generates a bid value for a candidate content item that is substantially equal to the expected attribution value for the content item. However, the online system 140 may alternatively use any of a variety of methods for generating 420 the bid value. For example, if a content generator 130 provides a minimum bid value for a candidate content item that represents a minimum amount of compensation the content generator 130 will provide to the online system for a candidate content item to be presented, the online system 140 may determine whether the expected value for the content item exceeds the minimum bid value. If the expected value is less than the minimum bid value, the online system 140 may select the minimum bid value rather than the expected value. Alternatively, the online system 140 may select the expected value rather than the minimum bid value, or may generate a bid value between the expected value and the minimum bid value (e.g., by computing the mean of the expected value and minimum value).

As another example, the online system 140 computes bid values by applying a specified formula to the expected value for a candidate content item. For example, the bid value is half of the expected value, or a fraction of the expected value plus a minimum bid value specified by the online system 140 or by a content generator 130. In still another example, the online system 140 selects bid values for specified ranges of expected values. For example, the online system 140 selects a bid value of $5 for candidate content items given expected values in the range from $0 to $9.99, a bid value of $15 for candidate content items with expected values in the range from $10 to $19.99, a bid value of $25 for expected values in the range from $20 to $29.99, and so forth. The online system 140 may alternatively use any number of other methods for generating bid values or selecting a content item based at least in part on the attribution models.

The online system 140 conducts 422 an auction between the candidate content items using the generated bid values, and selects a content item associated with a winning bid value for presentation to the user. Because the attribution models are trained based on the same attribution data that is sent to the content generators 130, the expected value of a content item that the online system 140 computes using the models will closely match the value observed by the content generators 130. The same value is observed by the content generators 130 and the online system 140 regardless of whether the interaction events contributing to desired interactions were detected by both the content generators 130 and the online system 140. The bid values generated by the online system 140 therefore match or closely correspond to the value ascribed to interaction events by the content generators 130.

### CONCLUSION

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving at an online system, a data stream of reported interaction events that resulted in a desired interaction associated with a content item, each reported interaction event associated with an attributed value defining a portion of a value of the desired interaction that is attributed to the interaction event;
training an attribution model associated with the content item using the attributed values in the received data stream, the attribution model configured to determine an expected attribution value to the online system of presenting the content item to a user of the online system;
generating an expected attribution value for the content item for presenting the content item to the user via an opportunity to present the content item, the expected attribution value being generated by the attribution model; and
selecting the content item for presentation to the user based on the expected attribution value.

2. The method of claim 1, wherein the attribution model generates the expected attribution value by applying characteristics of the opportunity to the attribution model.

3. The method of claim 1, further comprising:
training an attribution model associated with a content generator associated with the advertisement; and
generating the expected attribution value based on the attribution model associated with the content generator.

4. The method of claim 1, wherein the content item is selected based on targeting criteria provided by an advertiser associated with the content item.

5. The method of claim 2, wherein the data stream comprises reported interaction events associated with a plurality of content items, the method further comprising, for each of the plurality of content items:
training an attribution model for the content item using the reported interaction events in the data stream that are associated with the content item.

6. The method of claim 1, further comprising:
identifying an interaction event within the online system associated with the content item; and
reporting the identified interaction event to an attribution system configured to determine a value of a desired interaction attributed to the identified interaction event.

7. The method of claim 1, wherein each interaction event in the data stream includes a user action with respect to the content item.

8. The method of claim 1, wherein the expected attribution value is a proportion of influence the interaction event had on a desired interaction performed by a user on an associated content item or a monetary value of the interaction event.

9. The method of claim 1, wherein the content item is selected based on an auction process, and wherein the expected attribution value serves as a bid amount for the content item in the auction process.

10. The method of claim 1, further comprising: transmitting the content item to a client device operated by the user.

11. A non-transitory, computer-readable medium comprising computer-executable instructions that, when executed by a processor, cause the processor to:
receive at an online system, a data stream of reported interaction events that resulted in a desired interaction associated with a content item, each reported interaction event associated with an attributed value defining a portion of a value of the desired interaction that is attributed to the interaction event;
train an attribution model associated with the content item using the attributed values in the received data stream, the attribution model configured to determine an expected attribution value to the online system of presenting the content item to a user of the online system;
generate an expected attribution value for the content item for presenting the content item to the user via an opportunity to present the content item, the expected attribution value being generated by the attribution model; and
select the content item for presentation to the user based on the expected attribution value.

12. The computer-readable medium of claim 11, wherein the attribution model generates the expected attribution value by applying characteristics of the opportunity to the attribution model.

13. The computer-readable medium of claim 11, wherein the instructions further cause the processor to:
train an attribution model associated with a content generator associated with the advertisement; and
generate the expected attribution value based on the attribution model associated with the content generator.

14. The computer-readable medium of claim 11, wherein the content item is selected based on targeting criteria provided by an advertiser associated with the content item.

15. The computer-readable medium of claim 12, wherein the data stream comprises reported interaction events associated with a plurality of content items, and wherein the instructions further cause the processor to, for each of the plurality of content items:
train an attribution model for the content item using the reported interaction events in the data stream that are associated with the content item.

16. The computer-readable medium of claim 11, wherein the instructions further cause the processor to:
identify an interaction event within the online system associated with the content item; and
report the identified interaction event to an attribution system configured to determine a value of a desired interaction attributed to the identified interaction event.

17. The computer-readable medium of claim 11, wherein each interaction event in the data stream includes a user action with respect to the content item.

18. The computer-readable medium of claim 11, wherein the expected attribution value is a proportion of influence the interaction event had on a desired interaction performed by a user on an associated content item or a monetary value of the interaction event.

19. The computer-readable medium of claim 11, wherein the content item is selected based on an auction process, and wherein the expected attribution value serves as a bid amount for the content item in the auction process.

20. The computer-readable medium of claim 11, further comprising: transmitting the content item to a client device operated by the user.
